(19) United States
(12) Patent Application Publication
(10) Pub. No.: US 2025/0370157 A1
(43) Pub. Date: Dec. 4, 2025

(54) System & Method for Locating and/or Mapping of Utility Lines using an Electromagnetic Detecting Garment

(71) Applicant: John D. Andrews, Portland, OR (US)

(72) Inventor: John D. Andrews, Portland, OR (US)

(21) Appl. No.: 18/676,203

(22) Filed: May 28, 2024

(51) Int. Cl. G01V 3/08; G01V 3/36; H01Q 1/22

(52) U.S. Cl. CPC G01V 3/081; G01V 3/36; H01Q 1/22

(57) ABSTRACT

A system and method for detecting utility lines by using a somatosensory system integrated into a garment. The somatosensory system comprises a conducting wire loop, including conductive wire antennas a somatosensory ring, a processor, and an amplifier. The somatosensory system is integrated into a garment. The garment is worn by a worker then who walks through a test area. The somatosensory system then detects the utility by receiving electromagnetic data and the location is determined by the processor.

### BACKGROUND

The disclosed invention relates generally to a system and method for locating and/or mapping utility lines. Specifically, the system and method for locating both visible and buried utilities by detecting magnetic and/or electromagnetic radiation (EM) signals through an array of antennas or sensors integrated into a garment worn by a worker or a cover placed on a machine. The EM data, which is received and interpreted, is provided by signals from passive and active sources. The signals are received at different frequencies, orientations, polarities, strengths, spatial locations, time domains, and magnetic field configurations. The detector receives signals and processes the signals to locate the utility line.

The precise location of buried utilities such as electrical power lines, water and drain lines, gas lines, and telecommunication lines is imperative to prevent costly damage to infrastructure and ensure human safety. The precise location is required before excavation for repairs, improvements, surveys, and/or new construction can begin and be completed safely and without disruption to utility services. Traditional methods, employing handheld utility locator devices, rely on active and passive electromagnetic radiation or signal sensing. Active methods involve coupling signals onto target utilities via transmitters and interpreting feedback from locator devices. In contrast, passive techniques utilize existing signals to detect utilities, albeit with limitations in distinguishing between different lines.

Current methods are based on electromagnetic (EM) transmission and reception in the radio wavelength bands using a transmitter and a receiver, which are used together to ‘energize’ a target utility and then, with the receiver or wand, track that signal and mark or map it as needed. Attempts to improve this technology include GPS integration and remote or autonomous data collection systems; these systems are largely aimed at reducing cost and increasing safety and efficiency, but they do not improve accuracy. The current system manually monitors by a display and/or sound, allowing the workers to select and save data points for location. However, the system does not track continuously, and with multiple EM data sources, the system may give an indication of a location for the signal source, which is not correct. Incorrect location of signal sources often occurs in urban environments due to the dense network of utilities and complex infrastructure, including abandoned utilities. In urban environments, EM fields become distorted, making them more difficult to locate accurately; such distortion occurs near other utilities, large metallic objects, and things that can block or reflect the EM fields.

Various technologies have been employed to address these challenges, such as ground-penetrating radar (GPR). GPR utilizes high-frequency radio waves to image subsurface structures without soil disturbance, offering a safe and cost-effective method for utility detection. However, GPR is very limited in its detection capability and the areas where it can be used. Thus, there exists a need for a system and method to detect utilities precisely. Examples of the system and method to precisely detect utilities are provided below.

### SUMMARY

The invention is a system and method for locating utility lines. The system is a garment outfitted with a detecting device. The method comprises a worker moving through an area where buried or non-visible utilities may be located. The utility locating garments (wearables) can determine the spatial orientation of their own sensors in relation to the other sensors and, from there, determine the origin of radiations around them in reference to themselves. This data can be sent or connected to other nearby garments or processors for immediate use, analysis, or storage. The wearable garments locating apparatus can be used to integrate into pants, shoes, shirts, jackets, bags, packs, outerwear, headwear, and other wearable or clad-able items.

### BRIEF DESCRIPTION OF THE DRAWINGS

FIG. 1 shows the invention in use with a single electromagnetic field.

FIG. 2 shows examples of clothing articles that may incorporate the invention.

FIG. 3 shows the invention immersed in an electromagnetic field.

FIG. 4 shows a schematic of the invention.

FIG. 5 shows the invention incorporated into an article of clothing.

FIG. 6 shows the invention in use with multiple electromagnetic fields.

### DETAILED DESCRIPTION

The invention will become better understood through a review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various elements of the invention are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The invention is a system and method for locating and mapping buried utility lines using garments that are incorporated with a utility locating device, which together comprise a utility locating garment. Utility-locating garments can determine the spatial orientation of their own sensors in relation to the other sensors and, from there, determine the origin of radiations around them in reference to themselves. The data can be sent to other nearby garments or processors for immediate use, analysis, or storage. The system is powered by any conventional means, such as a battery pack or by induction.

The utility locating device may be integrated into a finished garment with non-limiting examples, including a shirt, a pair of pants, a jacket, a hat, a helmet, or footwear. Non-limiting examples of integration are an add-on to the finished garment, weaving into the base used to make the garment, sowing into the lining of a garment, heat pressed into the garment, or in the case of footwear-molding into the sole. The garment can be made from any suitable textile, natural or synthetic. The weave may include flexible wiring, flexible conductive wires, or smart fibers. Additionally, the utility locating device can be integrated into other items, with non-limiting examples including bags, cases, cladding, or coverings.

The utility locating device comprises antennas integrated into a garment. Amongst other features, the antennas can receive alternating current (AC) and detect magnetic fields emitted by any nearby utility, including buried, hidden, or inaccessible utilities. The antennas are computationally connected, giving each garment or section its own antenna array.

The antenna array may include one or more application-specific integrated circuits (ASICs) or processors connected to each of the antennas. One of the ASICs acts as a central processor which inputs the signal data from all receivers (either raw or preprocessed data). The central processor acts as the master controller for that specific garment or piece and is able to communicate with another nearby processor to allow a hierarchy of processing to allow the central processor to communicate with a nearby device such as a personal computer, cellphone, or mobile base station.

The antennas, coupled with the processing unit, create a utility locating system that can receive signals, compute the origin of all the signals, and define the location of the signals. The collected data can be stored locally as a standalone set or can be used to align with known landmarks or GIS data. The processing unit has a memory that stores all the incoming data it gets (which can change depending on how many preprocessors there are ahead of it) and which can be used for post-processing of the data and for record keeping. The memory is transferable either removably or electronically. The data can be sent to any connected device by wired or wireless means. Optionally, the transfer of data is accomplished by a central processor unit (CPU). The data can then be stored, processed, or displayed by any means then in use. The data may be sent to or received from other tools, including handheld locating tools, processors, personal computers, cellular phones, or other locating garments. This includes but is not limited to gathering or transferring data on the location of the garments so that a handheld locator or another device can display the information in real time for use in utility locating. Additionally, the locating clothes may contain a high-accuracy GIS information receiver and/or corrector, allowing the local data to be coupled to a GPS location or other data collected from a base station, a self-driving car, or a drone.

In one embodiment of the invention, the precise location, which is relevant to the garment, and the orientation of each antenna are known and recorded at every data reading. The precise location and orientation are determined by using the following non-limiting examples, including gyroscopes, electrical measurements, fractal antennas, elastic conductive wiring, ferrous core antennas, nickel-coated copper wire antennas, and smart fibers. In another embodiment of the invention, the garment can sense, vector, and plot magnetic fields by incorporating a flux-gate magnetometer into the receiving antennas.

When in use, the garment receives electromagnetic information, with non-limiting examples including AC magnetic fields, standing magnetic fields, oscillations emanated from a flowing electrical current, electromagnetic (EM) fields, EM oscillations, reflected EM energy, other types of EM, and from other sources of EM. The multiple antennas are connected to a processing unit, which determines the likely origin of the signals the antennas receive. The CPU analyzes the EM data and separates it into discreet classifications or energy levels, frequency ranges, or vectors. The processed EM data can be used to indicate the likely origin of each discreet division of the EM data. Alternatively, the antennas transmit EM energy, which interacts with buried marker balls. This may include but is not limited to existing EM marker ball frequencies and nonstandard frequencies.

Another method comprises computing the location of the ground-based sensors in communication with shoes or boots and integrating this data into a spatial map of the EM sources. The collected data can be combined with GIS data or geographic points of interest (POI), which may include but is not limited to determining where the bottom of shoes or boots were located in a three-dimensional spatial grid at specific times. The computed ‘ground level’ at each point in the spatial grid created for each job can be exported for immediate use, data retention, and analysis and can be incorporated into GIS data, POI, previous data sets, and other tools or processors.

System & Method for Locating and/or Mapping of Utility Lines Using an Electromagnetic Detecting Garment

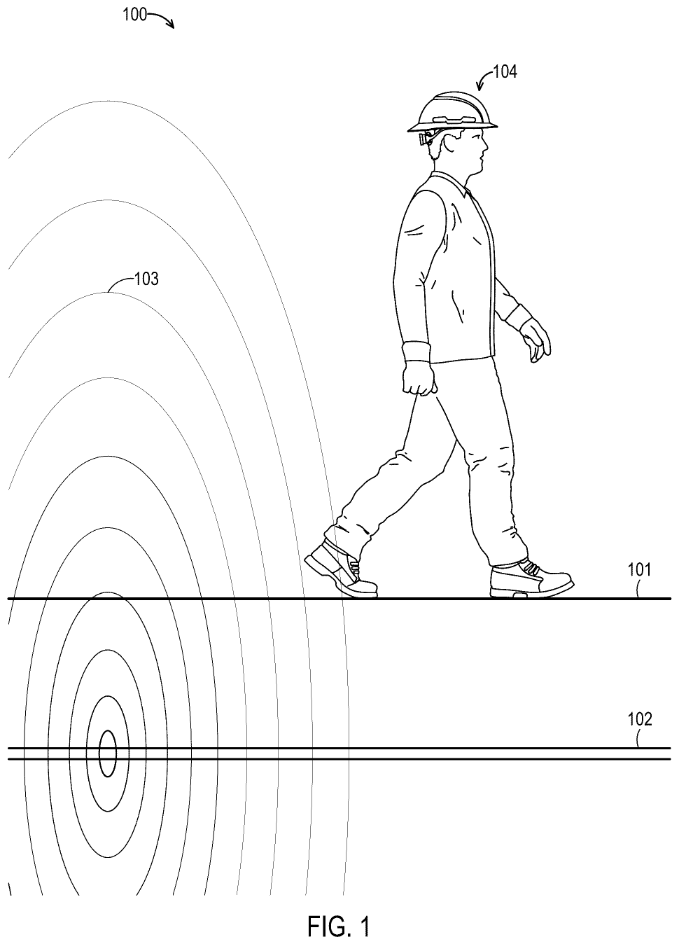

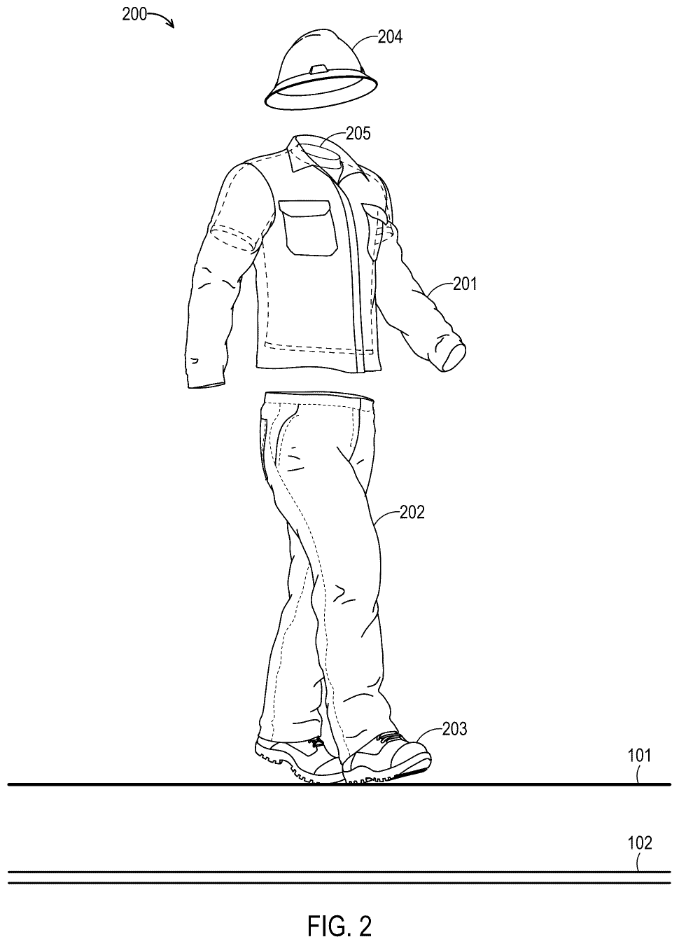

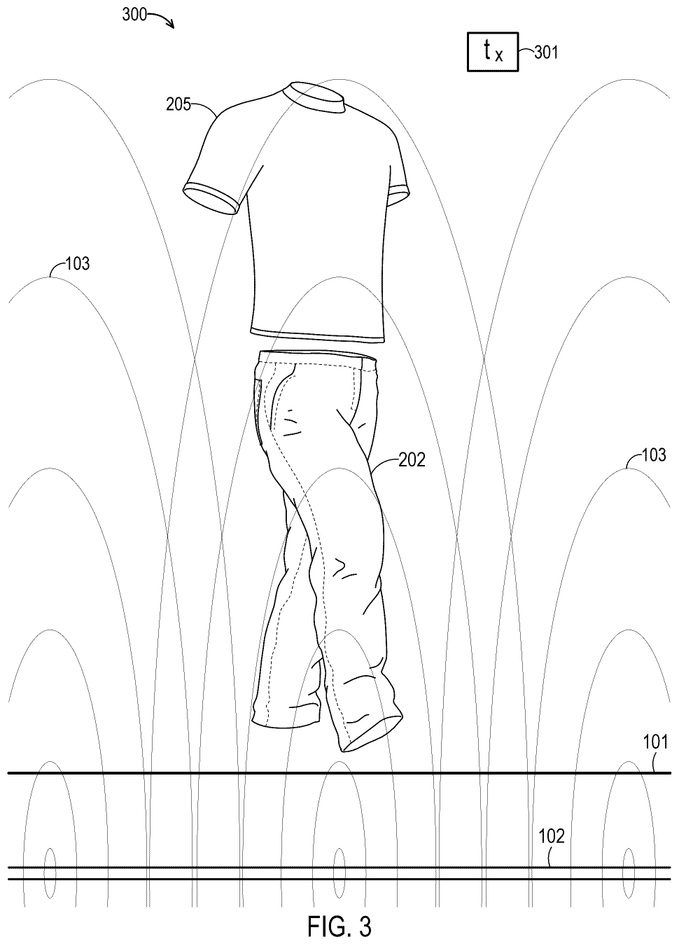

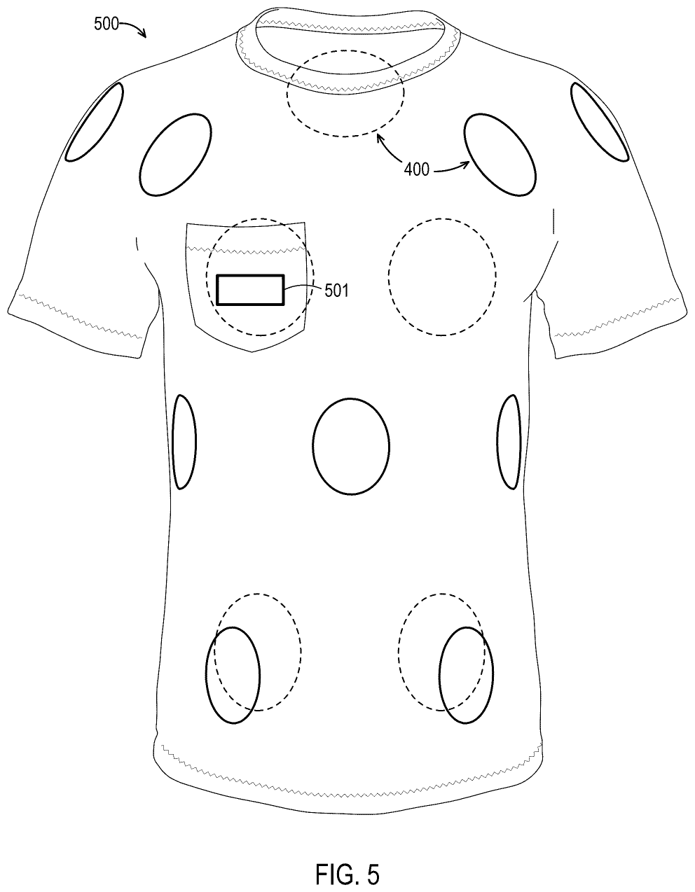

With reference to the figures, the System & Method for Locating and/or Mapping of Utility Lines using an Electromagnetic Detecting Garment will now be described. FIGS. 1 and 2 show the preferred elements of the present invention. The elements are articles of clothing, with non-limiting examples such as pants (202), a shirt (205), boots (203), outerwear (201), and a hard hat (204). The articles of clothing are integrated with a radiation sensing array, somatosensory system, and processor (FIGS. 5-9) worn by a worker (104) who operates by standing or moving on top of the ground surface (101). Wearing the utility locating suit or any of the utility locating clothes, the worker stands in an area or moves around in an area that has magnetic field differences and may contain one or more sources of radiation. The source of radiation is here demonstrated by a buried utility (103), but the suit is not limited to locating utility lines. Other sources of radiation, including point source beacons such as a sonde, can be located. The radiation waves (103) travel away from the source in all directions and can interact with themselves as well as the environment, which can create an EM field. This field is traditionally detected through antennas set in handheld utility locator machines, but this present disclosure incorporates this detection into garments. Each individual garment operates on its own and connects to other garments or processors to compute the relative location of radiation sources, as displayed in FIG. 1 and FIG. 3.

The antennas (402) in each garment store the incoming data at every time point (301). The garment processes the data at each time point (301) and then computes the distance and direction of the origin of the radiation and the difference in magnetic field. Each of the garments receives radiation from the surrounding sources (103) at each antenna (402) and measures the magnetic field (103) at a magnetic field sensor, which is translated into an electrical transmission or communication that is sent to the processor (404). The processor can transfer this information without modification (raw data) to another processor (405). The processor may also process the data according to a predefined configuration and transfer that processed data to a CPU (601), another garment, or to memory. When the data, processed or unprocessed, is communicated between multiple garments or other utility locating and or mapping tools, the CPU can use the collective data to determine the origin (103 and 301) of the signal(s). The EM radiation (103) that is captured is classified into discreet bands so the location of multiple sources of radiation can be computed. When multiple garments are nearby, they can share information through secure wireless communication, which can increase the size of the assembled antenna array.

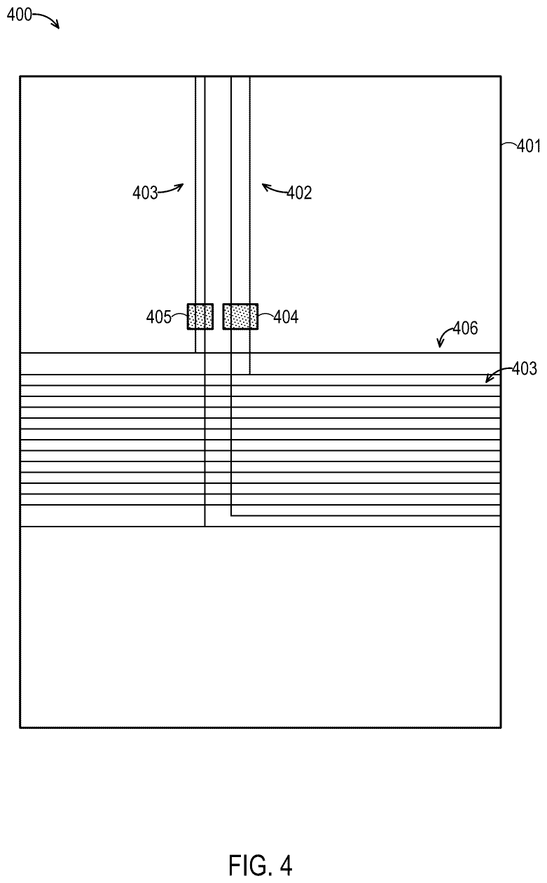

FIG. 4 shows the preferred embodiment of an antenna and somatosensory system, along with the accompanying wiring of a conductive wire loop (400 & 401). The antennas (401) can be interwoven into fabric or also embedded in synthetics. They can further be coated with additional fabric or textiles to create clothes, bags, or coverings. The conductive wire antennas (401) must form a conductive loop. The conductive wire antennas may have a somatosensory ring around them (406) or other location and/or orientation sensor. The somatosensory information from these sensors may be processed or amplified by a processor or electrical component (405), which is connected to elastic conductive wiring (403) and then transferred to the CPU for this garment. In other embodiments of this idea, the information is transferred wirelessly. The EM data (103) received by the elastic conductive wire or otherwise conductive wire antenna (407) goes to a connected processor and/or amplifier (404), which then sends that information to the CPU through wiring (402), which may or may not be made with flexible wiring.

Different antennas (401) can be selected for different garments; for example, a conductive wire antenna, a ferreous core, non-ferreous core or a fractal antenna can be incorporated into a garment (400) as seen in FIG. 4. A somatosensory sensor (406) capable of transferring the location and orientation of itself in reference to the other sensors or a base station, or a master GIS point can be incorporated into the garment by itself, at points around an antenna of any type, and surrounding an antenna 401. The information gathered here will allow the CPU to compute the strength and frequency of all received EM data from each antenna in each orientation at each time (301). Combining this information with other antennas and sensors can be used to compute the probable distance and location of the source of different EM radiations and/or magnetic fields (103). This data, over time and across a spatial area, can be processed in mass to give higher accuracy when trying to locate a utility. The EM data used to calculate the location of the utility can be transferred wirelessly through the CPU or other connected computer device to a base station or stored on memory for later retrieval.

FIG. 5 shows an embodiment of an article of clothing according to the invention. In this case, a work shirt (205) with a pocket and the CPU 601 is incorporated into this shirt under the pocket. FIG. 5 shows the possible locations of elements 400, the antennas (401), the wiring (403), and the CPU (601).

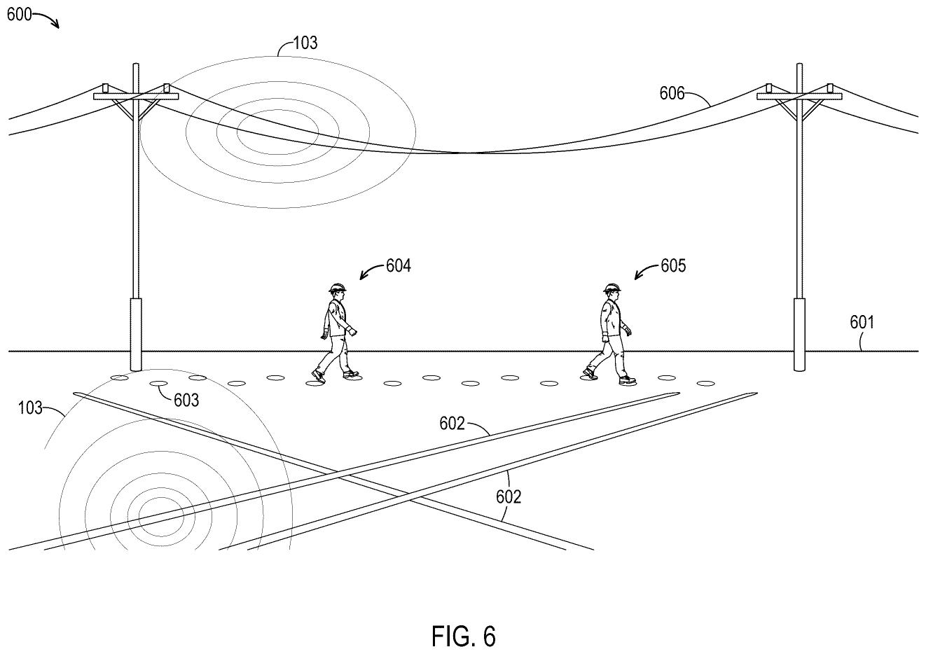

FIG. 6 we see a worker wearing or using the utility locating clothes or garments at two timestamps, t-1 (604) and t-2 (605); the path of the worker is visualized by their footsteps (1003). Multiple underground utilities (601) are present in the area, along with an overhead cable (1002). These lines may be emitting or reflecting active or passive EM signals (103) outward from their location. At one instant in this passage, that of t-1, the worker (604) is receiving EM data (103) that is processed to show the probable location of underground (103) and aboveground utilities (602). As the worker (1004) moves across the path (1003) or between the times of (604) and (605), the suit gathers and processes EM data (103) along with location data to produce the calculated location on all surrounding utilities over an area (600).

### Definitions

The following definitions apply herein unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

“Comprising.” “including.” and “having” (and conjugations thereof) are used interchangeably to mean including but not necessarily limited to and are open-ended terms not intended to exclude additional elements or method steps not expressly recited.

Terms such as “first.” “second.” and “third” are used to distinguish or identify various members of a group or the like and are not intended to denote a serial, chronological, or numerical limitation.

“Coupled” means connected. either permanently or releasably, whether directly or indirectly through intervening components.

“Communicatively coupled” means that an electronic device exchanges information with another electronic device, either wirelessly or with a wire-based connector, whether directly or indirectly, through a communication network.

“Controllably coupled” means that an electronic device controls the operation of another electronic device.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and sub-combinations of the various elements, features, functions, and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements, and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A somatosensory system comprising:
a conducting wire loop including:
conductive wire antennas and
a somatosensory ring; and
a processor; where the somatosensory ring is positioned around the conductive wire antennas; and the processor is connected to the conductive wire loop.

2. The somatosensory system of claim 1, where the orientation of the antennas is known; and the antennas may be selected from anyone of the following: a conductive wire antenna, a ferreous core, a non-ferreous core or a fractal antenna.

3. The somatosensory system of claim 2, further including an amplifier connected to the processor; wherein the amplifier is configured to process somatosensory information received from the somatosensory ring.

4. The somatosensory system of claim 3, wherein the processor is configured to compute strength and frequency of all received electromagnetic data; and the processor is configured to compute a location of a radiation source based on the received electromagnetic data.

5. The somatosensory system of claim 4, where the processor computes the location of a radiation source by classifying the received electromagnetic data into discreet bands.

6. The somatosensory system of claim 5, where the processor is configured to communicate with a geographic information system or a global positioning system.

7. The somatosensory system of claim 6, where the processor may be an application-specific integrated circuit or a central processing unit.

8. The somatosensory system of claim 7, where received electromagnetic data can be transferred by wireless or wired means or stored; and the application-specific integrated circuit or the central processing unit further includes a memory to store the received electromagnetic data.

9. The somatosensory system of claim 8, where the stored data can be transferred by wireless or wired communication, or by removable storage media.

10. A utility detecting garment comprising: a garment and at least one somatosensory system of claim 8 attached to the garment.

11. The utility detecting garment of claim 9 where the garment further comprises at least one of the following: a pair of pants, a pair of shoes, a shirt, a jacket, outerwear, headwear, or boots.

12. A utility detecting article comprising: an article and at least one somatosensory system of claim 8.

13. The article of claim 12 where at least one article is selected from: a backpack, a bag, a tarp, case, or cladding.

14. A utility detecting antenna array comprising: providing a worker donning at least two of the garments provided in claim 11.

15. A method for passively receiving electromagnetic data by passing the somatosensory system of claim 8 through a magnetic field.

16. A method for detecting utilities comprising: (1) providing at least one worker; (2) providing a test area, (3) having the worker don at least one of the utility detecting garments provided in claim 11; and (4) having the worker walk through the test area.

17. A method for detecting utilities comprising: (1) providing at least one worker; (2) providing a test area, (3) having the worker carry at least one utility detecting article provided in claim 13; and (4) having the worker walk through the test area.
